(19) United States
(12) Patent Application Publication
(10) Pub. No.: US 2018/0042810 A1
(43) Pub. Date: Feb. 15, 2018

(54) Massaging Garment System

(71) Applicant: Loc Nguyen, Elk Grove, CA (US)

(72) Inventor: Loc Nguyen, Elk Grove, CA (US)

(21) Appl. No.: 15/233,022

(22) Filed: Aug. 10, 2016

(51) Int. Cl. A61H 23/02

(52) U.S. Cl. CPC A61H 23/02; A61H 2205/108; A61H 2205/088; A61H 2205/102; A61H 2205/06; A61H 2205/04; A61H 2205/062; A61H 2205/081; A61H 2205/084; A61H 2201/1207; A61H 2201/5097

(57) ABSTRACT

A massaging garment system includes an electronic device that may be manipulated. A plurality of garments is provided and each of the garments is worn on a selected part of a user's body. Each of the garments has a first wall and a second wall that is spaced from the first wall to define a massage space in each of the garments. A plurality of massage units is provided. Each of the massage units is positioned within the massage space of an associated one of the garments. Thus, each of the massage units may massage the user's body thereby facilitating each of the massage units to relieve pain. Each of the massage units is in electrical communication with the electronic device. Thus, the electronic device controls operational parameters of the plurality of massage units.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to garment devices and more particularly pertains to a new garment device for massaging selected areas of a user's body.

### BRIEF SUMMARY OF THE INVENTION

An embodiment of the disclosure meets the needs presented above by generally comprising an electronic device that may be manipulated. A plurality of garments is provided and each of the garments is worn on a selected part of a user's body. Each of the garments has a first wall and a second wall that is spaced from the first wall to define a massage space in each of the garments. A plurality of massage units is provided. Each of the massage units is positioned within the massage space of an associated one of the garments. Thus, each of the massage units may massage the user's body thereby facilitating each of the massage units to relieve pain. Each of the massage units is in electrical communication with the electronic device. Thus, the electronic device controls operational parameters of the plurality of massage units.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front in-use view of a massaging garment system according to an embodiment of the disclosure.

FIG. 2 is a back in-use view of an embodiment of the disclosure.

FIG. 3 is a perspective view of a sleeve of an embodiment of the disclosure.

FIG. 4 is a front phantom view of a sleeve of an embodiment of the disclosure.

FIG. 5 is a cross sectional view taken along line 5-5 of FIG. 4 of an embodiment of the disclosure.

### DETAILED DESCRIPTION OF THE INVENTION

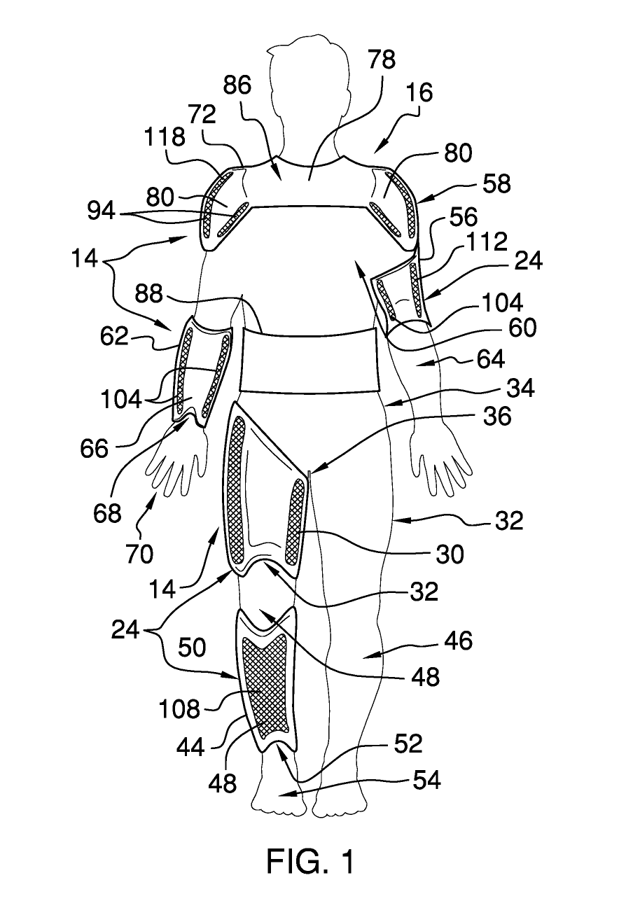

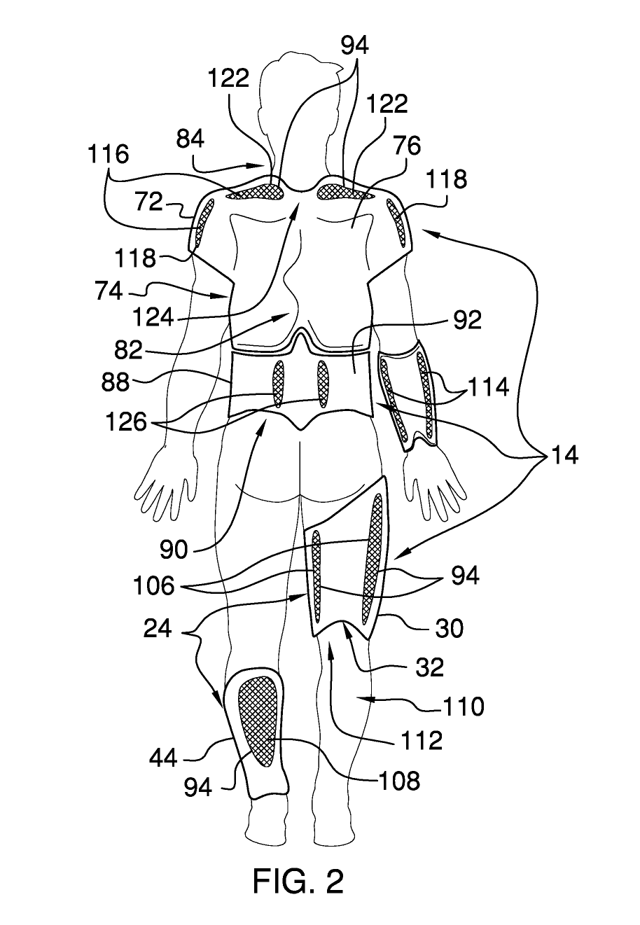

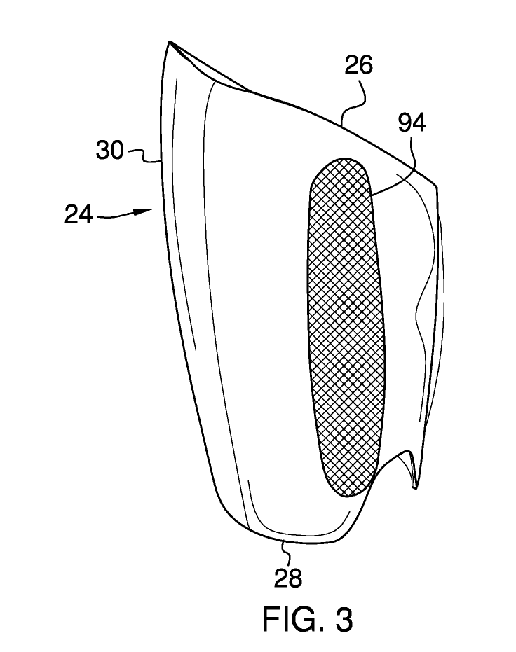

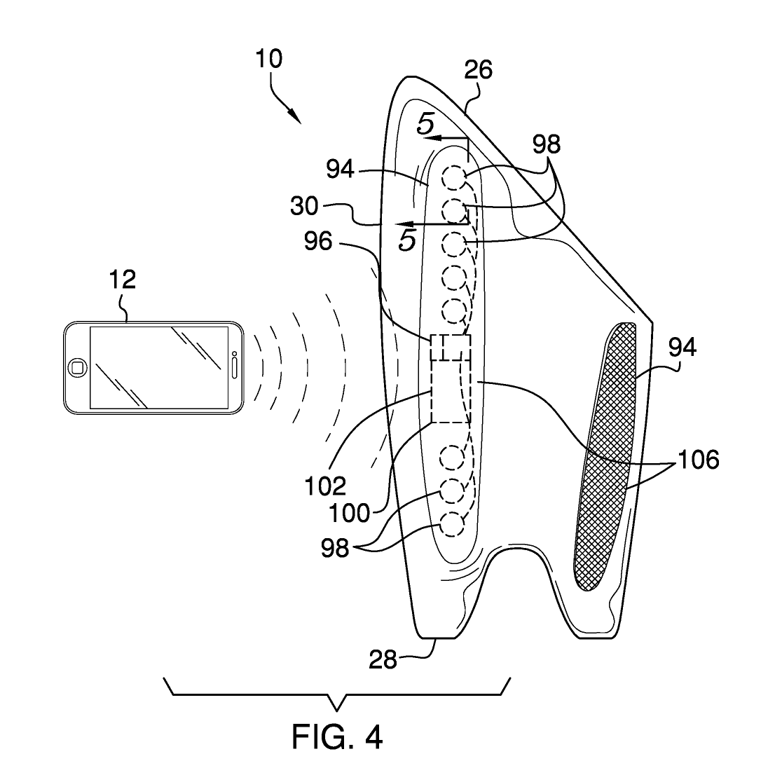

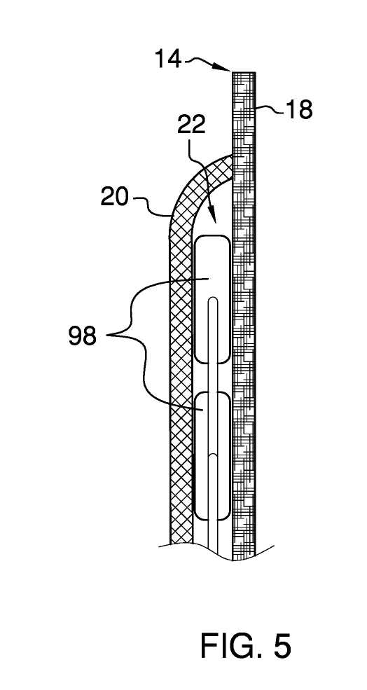

With reference now to the drawings, and in particular to FIGS. 1 through 5 thereof, a new garment device embodying the principles and concepts of an embodiment of the disclosure and generally designated by the reference numeral 10 will be described.

As best illustrated in FIGS. 1 through 5, the massaging garment system 10 generally comprises an electronic device 12 that may be manipulated. The electronic device 12 may be a smart phone or the like. A plurality of garments 14 is provided and each of the garments 14 may be worn on a selected part of a user's body 16. Each of the garments 14 has a first wall 18 and a second wall 20. The second wall 20 is spaced from the first wall 18 to define a massage space 22 in each of the garments 14. Each of the garments 14 may be comprised of a resiliently stretchable and fluid impermeable material.

The plurality of garments 14 comprises a plurality of sleeves 24 and each of the sleeves 24 may be worn on a selected limb. Each of the sleeves 24 has a top edge 26 and a bottom edge 28. The plurality of sleeves 24 comprises at least one thigh sleeve 30 that may be worn on the user's thigh 32. The top edge 26 of the at least one thigh sleeve 30 is angled. Thus, the top edge 26 of the at least one thigh sleeve 30 travels between the user's hip 34 and the user's crotch 36. The bottom edge 28 of the at least one thigh sleeve 30 is scalloped to define a pair of knee exposures 38. Thus, each of the knee exposures 38 exposes the user's knee cap 40 and a back of the user's knee 42.

At least one shin sleeve 44 is provided and the at least one shin sleeve 44 may be worn on a shin 46. The at least one shin sleeve 44 has a front side 48. The top edge 26 of the at least one shin sleeve 44 is scalloped on the front side 48 to define a knee exposure 50. Thus, the knee exposure 50 on the at least one shin sleeve 44 exposes the user's knee cap 40. The top edge 26 of the at least one shin sleeve 44 is scalloped on the front side 48 to define an ankle exposure 52. Thus, the ankle exposure 52 follows a contour of a top of the user's foot 54.

At least one upper arm sleeve 56 is provided. The at least one upper arm sleeve 56 may be worn on the user's upper arm 57. The top edge 26 of the at least one upper arm sleeve 56 is angled. Thus, the top edge 26 of the at least one upper arm sleeve 56 extends between the user's shoulder 58 and the user's armpit 60.

At least one forearm sleeve 62 is provided. The at least one forearm sleeve 62 may be worn on the user's forearm 64. The at least one forearm sleeve 62 has a forward side 66. The bottom edge 28 of the at least one forearm sleeve 62 is scalloped on the forward side 66. Thus, a wrist exposure 68 is defined to facilitate the user's hand 70 to move when the at least one forearm sleeve 62 is worn.

A shirt 72 is provided and the shirt 72 may be worn on the user's torso 74. The shirt 72 has a back side 76, a front side 78 and a pair of shoulders 80. The back side 76 has a height that is greater than a height of the front side 78. The back side 76 extends between the user's middle back 82 and the user's neck 84. The front side 48 extends between the user's upper chest 86 and the user's neck 84.

A belt 88 is provided. The belt 88 may be worn around the user's lower back 90. The belt 88 has a rearward side 92. The rearward side 92 abuts the user's lower back 90.

A plurality of massage units 94 is provided. Each of the massage units 94 is positioned within the massage space 22 of an associated one of the garments 14. Each of the massage units 94 massages the user's body 16. Thus, each of the massage units 94 relieves pain related to muscular tension or muscular injury.

Each of the massage units 94 is in electrical communication with the electronic device 12. Thus, the electronic device 12 controls operational parameters of the plurality of massage units 94. The electronic device 12 may store a control app or the like. Additionally, each of the massage units 94 may employ Bluetooth communication protocols. Each of the massage units 94 may be selectively synched with the electronic device 12. Thus, each of the massage units 94 may be selectively controlled with the electronic device 12.

The plurality of massage units 94 comprises a receiver 96 that is in electrical communication with the electronic device 12. The receiver 96 may be a radio frequency receiver 96 or the like. A plurality of massage pads 98 is provided. Each of the massage pads 98 is electrically coupled to the receiver 96. Each of the massage pads 98 may be electrical massage pads 98 or the like. Moreover, each of the massage pads 98 may be vibrational massage pads 98 or the like.

A power supply 100 is provided. The power supply 100 is electrically coupled to the receiver 96. The power supply 100 comprises at least one battery 102. The at least one battery 102 may be a rechargeable battery 102. Moreover, the at least one battery 102 may be a wirelessly charged battery 102 or the like. Thus, the at least one battery 102 may be placed on a wireless charging station or the like to charge the battery 102.

The plurality of massage pads 98 comprises a plurality of sleeve massage pads 104. Each of the sleeve massage pads 104 is positioned within an associated one of the sleeves 24. The sleeve massage pads 104 are spaced apart from each other and are distributed between the top edge 26 and the bottom edge 28 of the associated sleeve. The plurality of sleeve massage pads 104 comprises a pair of sets of sleeve massage pads 104. The sets of sleeve massage pads 104 are spaced apart from each other.

The plurality of sleeve massage pads 104 comprises a plurality of thigh massage pads 106. Each of the thigh massage pads 106 is positioned within the at least one thigh sleeve 30. Thus, each of the thigh massage pads 106 massages the user's thigh 32. A plurality of shin massage pads 108 is provided. Each of the shin massage pads 108 is positioned within the at least one shin sleeve 44. Thus, the plurality of shin massage pads 108 massages a front of the user's shin 46 and the user's calf 110.

A plurality of upper arm massage pads 112 is provided. Each of the upper arm massage pads 112 is positioned within the at least one upper arm sleeve 56. Thus, each of the upper arm massage pads 112 massages the user's upper arm 57. A plurality of forearm massage pads 114 is provided. Each of the forearm massage pads 114 is positioned within the at least one forearm sleeve 62. Thus, each of the forearm massage pads 114 massages the user's forearm 64.

A plurality of shirt massage pads 116 is provided and each of the shirt massage pads 116 is positioned in the shirt 72. The plurality of shirt massage pads 116 comprises a plurality of shoulder massage pads 118. Each of the shoulder massage pads 118 is positioned within an associated one of the shoulders 80 in the shirt 72. Thus, each of the second shoulder massage pads 118 massages an associated one of the user's shoulders 120.

A plurality of upper back massage pads 122 is provided. Each of the upper back massage pads 122 is positioned in the back side 76 of the shirt 72. Thus, each of the upper back massage pads 122 massages the user's upper back 124. A plurality of belt massage pads 126 is provided. Each of the belt massage pads 126 is positioned in the rearward side 92 of the belt 88. Thus, each of the belt massage pads 126 massages the user's lower back 90.

In use, each of the garments 14 is selectively worn on the associated part of the user's body 16. The electronic device 12 is manipulated to control the operational parameters of the massage units 94 in the selected garment. Thus, the massage units 94 in the selected garment massage the associated port of the user's body 16. Each of the garments 14 may be worn beneath clothing while the user is moving or working. Additionally, each of the garments 14 may be worn while the user is lying down or resting.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A massaging garment system being configured to selectively massage an area of a body, said system comprising:
an electronic device being configured to be manipulated;
a plurality of garments, each of said garments being configured to be worn on a selected part of a user's body, each of said garments having a first wall and a second wall being spaced from said first wall to define a massage space in each of said garments; and
a plurality of massage units, each of said massage units being positioned within said massage space of an associated one of said garments wherein each of said massage units is configured to massage the user's body thereby facilitating each of said massage units to relieve pain, each of said massage units being in electrical communication with said electronic device such that said electronic device controls operational parameters of said plurality of massage units.

2. The system according to claim 1, wherein said plurality of garments comprises a plurality of sleeves, each of said sleeves being configured to be worn on a selected limb, each of said sleeves having a top edge and a bottom edge.

3. The system according to claim 2, wherein said plurality of sleeves comprises at least one thigh sleeve being configured to be worn on the user's thigh, said top edge of said at least one thigh sleeve being angled wherein said top edge of said at least one thigh sleeve is configured to travel between the user's hip and the user's crotch, said bottom edge of said at least one thigh sleeve being scalloped to define a pair of knee exposures wherein each of said knee exposures is configured to expose an the user's knee cap and a back of the user's knee.

4. The system according to claim 2, further comprising at least one shin sleeve being configured to be worn on a shin, said at least one shin sleeve having a front side, said top edge of said at least one shin sleeve being scalloped on said front side to define a knee exposure wherein said knee exposure on said at least one shin sleeve is configured to expose the user's knee cap, said top edge of said at least one shin sleeve being scalloped on said front side to define an ankle exposure wherein said ankle exposure is configured to follow a contour of a top of the user's foot.

5. The system according to claim 2, further comprising at least one upper arm sleeve being configured to be worn on the user's upper arm, said top edge of said at least one upper arm sleeve being angled wherein said top edge of said at least one upper arm sleeve is configured to extend between the user's shoulder and the user's armpit.

6. The system according to claim 2, further comprising at least one forearm sleeve being configured to be worn on the user's forearm, said at least one forearm sleeve having a forward side, said bottom edge of said at least one forearms sleeve being scalloped on said forward side to define a wrist exposure wherein said wrist exposure is configured to facilitate the user's hand to move when said at least one forearm sleeve is worn.

7. The system according to claim 1, wherein said plurality of garments comprises a shirt being configured to be worn on the user's torso, said shirt having a back side, a front side and a pair of shoulders, said back side having a height being greater than a height of said front side, said back side being configured to extend between the user's middle back and the user's neck, said front side being configured to extend between the user's upper chest and the user's neck.

8. The system according to claim 1, wherein said plurality of garments comprises a belt being configured to be worn around the user's lower back, said belt having a rearward side wherein said rearward side is configured to abut the user's lower back.

9. The system according to claim 1, wherein said plurality of massage units comprises:
a receiver being in electrical communication with said electronic device;
a plurality of massage pads, each of said massage pads being electrically coupled to said receiver; and
a power supply being electrically coupled to said receiver, said power supply comprising at least one battery.

10. The system according to claim 9, wherein:
said plurality of garments includes a plurality of sleeves, each of said sleeves having a top edge and a bottom edge; and
said plurality of massage pads comprises a plurality of sleeve massage pads, each of said sleeve massage pads being positioned within an associated one of said sleeves, said sleeve massage pads being spaced apart from each other and being distributed between said top edge and said bottom edge of said associated sleeve, said plurality of sleeve massage pads comprising a pair of sets of sleeve massage pads, said sets of sleeve massage pads being spaced apart from each other.

11. The system according to claim 10, wherein:
said plurality of sleeves includes at least one thigh sleeve; and
said plurality of sleeve massage pads comprises a plurality of thigh massage pads, each of said thigh massage pads being positioned within said at least one thigh sleeve wherein each of said thigh massage pads is configured to massage the user's thigh.

12. The system according to claim 10, wherein:
said plurality of sleeves includes at least one shin sleeve; and
a plurality of shin massage pads, each of said shin massage pads being positioned within said at least one shin sleeve wherein said plurality of shin massage pads is configured to massage a front of the user's shin and the user's calf.

13. The system according to claim 10, wherein:
said plurality of sleeves includes at least one upper arm sleeve; and
a plurality of upper arm massage pads, each of said upper arm massage pads being positioned within said at least one upper arm sleeve wherein each of said upper arm massage pads is configured to massage the user's upper arm.

14. The system according to claim 10, wherein:
said plurality of sleeves includes at least one forearm sleeve; and
a plurality of forearm massage pads, each of said forearm massage pads being positioned within said at least one forearm sleeve wherein each of said forearm massage pads is configured to massage the user's forearm.

15. The system according to claim 9, wherein:
said plurality of garments includes a shirt, said shirt having a pair of shoulders and a back side; and
said plurality of massage pads includes a plurality of shirt massage pads, each of said shirt massage pads being positioned in said shirt.

16. The system according to claim 15, wherein said plurality of shirt massage pads comprises:
a plurality of shoulder massage pads being positioned within an associated one of said shoulders in said shirt wherein each of said second shoulder massage pads is configured to massage an associated one of the user's shoulders; and
a plurality of upper back massage pads, each of said upper back massage pads being positioned in said back side of said shirt wherein each of said upper back massage pads is configured to massage the user's upper back.

17. The system according to claim 9, wherein:
said plurality of garments includes a belt, said belt having a rearward side; and
said plurality of massage pads includes a plurality of belt massage pads, each of said belt massage pads being positioned in said rearward side of said belt wherein each of said belt massage pads is configured to massage the user's lower back.

18. A massaging garment system being configured to selectively massage an area of a body, said system comprising:
an electronic device being configured to be manipulated;
a plurality of garments, each of said garments being configured to be worn on a selected part of a user's body, each of said garments having a first wall and a second wall being spaced from said first wall to define a massage space in each of said garments, said plurality of garments comprising:
a plurality of sleeves, each of said sleeves being configured to be worn on a selected limb, each of said sleeves having a top edge and a bottom edge, said plurality of sleeves comprising:
at least one thigh sleeve being configured to be worn on the user's thigh, said top edge of said at least one thigh sleeve being angled wherein said top edge of said at least one thigh sleeve is configured to travel between the user's hip and the user's crotch, said bottom edge of said at least one thigh sleeve being scalloped to define a pair of knee exposures wherein each of said knee exposures is configured to expose an the user's knee cap and a back of the user's knee,
at least one shin sleeve being configured to be worn on a shin, said at least one shin sleeve having a front side, said top edge of said at least one shin sleeve being scalloped on said front side to define a knee exposure wherein said knee exposure on said at least one shin sleeve is configured to expose the user's knee cap, said top edge of said at least one shin sleeve being scalloped on said front side to define an ankle exposure wherein said ankle exposure is configured to follow a contour of a top of the user's foot,
at least one upper arm sleeve being configured to be worn on the user's upper arm, said top edge of said at least one upper arm sleeve being angled wherein said top edge of said at least one upper arm sleeve is configured to extend between the user's shoulder and the user's armpit, and
at least one forearm sleeve being configured to be worn on the user's forearm, said at least one forearm sleeve having a forward side, said bottom edge of said at least one forearms sleeve being scalloped on said forward side to define a wrist exposure wherein said wrist exposure is configured to facilitate the user's hand to move when said at least one forearm sleeve is worn, and
a shirt being configured to be worn on the user's torso, said shirt having a back side, a front side and a pair of shoulders, said back side having a height being greater than a height of said front side, said back side being configured to extend between the user's middle back and the user's neck, said front side being configured to extend between the user's upper chest and the user's neck, and
a belt being configured to be worn around the user's lower back, said belt having a rearward side wherein said rearward side is configured to abut the user's lower back;
a plurality of massage units, each of said massage units being positioned within said massage space of an associated one of said garments wherein each of said massage units is configured to massage the user's body thereby facilitating each of said massage units to relieve pain, each of said massage units being in electrical communication with said electronic device such that said electronic device controls operational parameters of said plurality of massage units, said plurality of massage units comprising:
a receiver being in electrical communication with said electronic device,
a plurality of massage pads, each of said massage pads being electrically coupled to said receiver,
a power supply being electrically coupled to said receiver, said power supply comprising at least one battery, and
said plurality of massage pads comprising:
a plurality of sleeve massage pads, each of said sleeve massage pads being positioned within an associated one of said sleeves, said sleeve massage pads being spaced apart from each other and being distributed between said top edge and said bottom edge of said associated sleeve, said plurality of sleeve massage pads comprising a pair of sets of sleeve massage pads, said sets of sleeve massage pads being spaced apart from each other, said plurality of sleeve massage pads comprising:
a plurality of thigh massage pads, each of said thigh massage pads being positioned within said at least one thigh sleeve wherein each of said thigh massage pads is configured to massage the user's thigh,
a plurality of shin massage pads, each of said shin massage pads being positioned within said at least one shin sleeve wherein said plurality of shin massage pads is configured to massage a front of the user's shin and the user's calf,
a plurality of upper arm massage pads, each of said upper arm massage pads being positioned within said at least one upper arm sleeve wherein each of said upper arm massage pads is configured to massage the user's upper arm, and
a plurality of forearm massage pads, each of said forearm massage pads being positioned within said at least one forearm sleeve wherein each of said forearm massage pads is configured to massage the user's forearm;
a plurality of shirt massage pads, each of said shirt massage pads being positioned in said shirt, said plurality of shirt massage pads comprising:
a plurality of shoulder massage pads being positioned within an associated one of said shoulders in said shirt wherein each of said second shoulder massage pads is configured to massage an associated one of the user's shoulders, and
a plurality of upper back massage pads, each of said upper back massage pads being positioned in said back side of said shirt wherein each of said upper back massage pads is configured to massage the user's upper back; and
a plurality of belt massage pads, each of said belt massage pads being positioned in said rearward side of said belt wherein each of said belt massage pads is configured to massage the user's lower back.
